(19) United States
(12) Patent Application Publication
(10) Pub. No.: US 2026/0159010 A1
(43) Pub. Date: Jun. 11, 2026

(54) REMOVABLE FIXING DEVICE FOR VEHICLE COMPONENT

(71) Applicants: Hyundai Motor Company, Seoul (KR); Kia Corporation, Seoul (KR); PIOLAX CO., LTD., Incheon (KR)

(72) Inventors: Jin Seok YOON, Hwaseong-si (KR); Jae Eun CHANG, Hwaseong-si (KR); Seong Jin KIM, Incheon (KR)

(21) Appl. No.: 19/199,969

(22) Filed: May 6, 2025

(30) Foreign Application Priority Data
Dec. 6, 2024 (KR) 10-2024-0180477

(51) Int. Cl. B60R 13/02

(52) U.S. Cl. CPC B60R 13/0206

(57) ABSTRACT

The present disclosure discloses a removable fixing device for a vehicle component. The fixing device allows a convenience component to be mounted to or removed from the interior of the vehicle, thereby ensuring greater flexibility in the use of the convenience component and improving the convenience of use. The removable fixing device also allows a device for fixing a convenience component to be separately mounted to or removed from the vehicle, thereby making it easy to replace the fixing device in the event of a malfunction and simplifying management. In addition, the convenience component is easy to mount, enhancing the convenience of use.

### CROSS-REFERENCE TO RELATED APPLICATION(S)

This application is based on and claims priority under 35 U.S.C. 119 to Korean Patent Application No. 10-2024-0180477, filed on Dec. 6, 2024, in the Korean Intellectual Property Office, the disclosure of which is herein incorporated by reference in its entirety.

### TECHNICAL FIELD

The present disclosure relates to a removable fixing device for vehicle components, which allows various convenience components to be mounted to or removed from a vehicle interior and also enables structures for fixing these components to be mounted or removed.

### BACKGROUND

A vehicle may include various convenience components in the interior for a user convenience. For example, the convenience components may include cup holders for holding beverages, pockets for storing various items, and hangers for hanging and storing clothes, which are mounted on the interior trim.

In some cases, when the convenience components are applied to the vehicle interior, their installation positions may be determined during the initial design phase and provided only in the forms determined at that time.

In some cases, the structures for fixing the convenience components may be provided at positions predetermined according to the initial design, and when these structures are damaged, replacement of the components may be difficult, making them inconvenient to use and difficult to maintain.

### SUMMARY

The present disclosure describes a fixing structure enabling convenience components to be mounted to or removed from the interior of a vehicle, thereby ensuring freedom of use of the convenience components and enhancing convenience of their use.

The present disclosure further describes a removable device for vehicle components that can be separately mounted or removed from the vehicle, thereby facilitating replacement in the event of a malfunction of the fixing device and simplifying maintenance.

According to one aspect of the subject matter described in this application, a fixing device for a vehicle component includes a fixing part configured to be coupled to a vehicle, the fixing part including a connection portion, an assembly part including (i) a first fastening portion that is fastened to the connection portion of the fixing part and configured to be mounted to and removed from the fixing part, and (ii) a second fastening portion spaced apart from the first fastening portion, and a fixing unit including a coupling portion that is configured to be mounted to and removed from the second fastening portion of the assembly part, the fixing unit being configured to be attached to and detached from the vehicle component.

Implementations according to this aspect can include one or more of the following features. For example, the fixing part can be configured to be coupled to a panel portion of the vehicle, where the panel portion has a through-hole configured to accommodate a portion of the assembly part, and the fixing part has a corresponding through-hole facing the through-hole of the panel portion.

In some implementations, the connection portion of the fixing part can be one of a plurality of connection portions that are arranged along an edge of the fixing part and that define a plurality of through-holes, respectively. The first fastening portion of the assembly part can be one of a plurality of first fastening portions corresponding to the plurality of connection portions, respectively, where each of the plurality of first fastening portions is inserted through and mounted in one of the plurality of connection portions.

In some implementations, the assembly part includes a first plate including the first fastening portion configured to be fastened to the connection portion of the fixing part, the first plate defining at least one slot, and a second plate including the second fastening portion matching the at least one slot of the first plate, where the coupling portion of the fixing unit is mounted to the assembly part through the second fastening portion. In some examples, the first plate can cover the second plate and be disposed inward toward an interior of the vehicle relative to the second plate, where the coupling portion of the fixing unit passes through the at least one slot in the first plate and is mounted to the second fastening portion of the second plate.

In some implementations, the first fastening portion can include a fixing portion that is fixed to the first plate and protrudes outward from the first plate, the fixing portion defining a mounting hole, and an assembly portion that receives the fixing portion. The assembly portion can include a fitting portion configured to be fitted into the mounting hole of the fixing portion, an inclined portion having an exterior configured to elastically deform, and an engagement end portion fastened to the connection portion and disposed at a distal end of the fitting portion or the inclined portion.

In some examples, the second plate can include a third fastening portion fastened to a bracket that is fixed to the vehicle. In some implementations, the third fastening portion can includes a seating portion seated on the second plate, a pair of support portions that extend from the seating portion and are inclined with respect to the seating portion, where the pair of support portions define a space therebetween, and ends of the pair of support portions are connected to each other, and a pair of engagement portions connected to the pair of support portions, respectively, and configured to elastically deform inward or outward relative to the pair of support portions.

In some implementations, the second plate includes a mounting portion that protrudes from the second plate, and an engagement protrusion that protrudes from the mounting portion, where the third fastening portion can include a mounting end portion disposed at the seating portion and configured to receive the mounting portion. The engagement protrusion can be configured to be fixedly engaged with the mounting portion based on the mounting portion passing through the mounting end portion.

In some implementations, the bracket has a fastening hole defined therein, where the pair of engagement portions are inclined at a greater angle than the pair of support portions and protrude outward relative to the pair of support portions. The pair of engagement portions can be configured to engage with the bracket by passing through the fastening hole and a contracting and expanding action to thereby fasten the third fastening portion to the bracket.

In some examples, the third fastening portion can include an extension disposed in the space between the pair of support portions and connected to at least one of the seating portion, the pair of support portions, or the pair of engagement portions, where the first plate, the second plate, and the third fastening portion can be assembled via a fastening member that passes through and is fastened to the first plate, the second plate, and the extension of the third fastening portion.

In some implementations, the at least one slot in the first plate extends linearly, where the coupling portion of the fixing unit has a shape corresponding to the at least one slot and is configured to be fixed to the second plate based on the coupling portion being inserted through the at least one slot in the first plate and then being rotated.

In some examples, the second fastening portion includes a peripheral portion that surrounds a circular hole defined through the second plate, a contact portion positioned at a center of the peripheral portion and configured to support the coupling portion of the fixing unit, a bridge portion connecting the peripheral portion to the contact portion, and a locking portion configured to constrain a position of the coupling portion based on a rotation of the fixed unit while the coupling portion of the fixing unit is in contact with the contact portion.

In some implementations, the coupling portion of the fixing unit includes an insertion portion that protrudes from a center thereof, and the contact portion defines an insertion hole configured to receive the insertion portion. In some examples, the locking portion includes a first guide portion that extends in a circumferential direction of the peripheral portion and protrudes radially inward, and a second guide portion that extends in the circumferential direction with the first guide portion and is configured to seat the coupling portion thereon.

In some implementations, the contact portion includes a protrusion that protrudes in a direction facing the coupling portion of the fixing unit, that extends in the circumferential direction, and that is configured to guide a rotation of the coupling portion, the protrusion having a recess configured to constrain the rotation of the coupling portion.

In some implementations, the fixing unit includes a housing that defines a mounting space configured to accommodate the vehicle component, where the coupling portion is provided outside the housing, and a cover that is rotatably connected to the housing and configured to cover a portion of the mounting space. In some examples, the cover includes a hook portion and a cover portion that are configured to come into contact with at least a part of the vehicle component, where the hook portion is configured to, based on the cover being positioned in an open state, come into contact with the vehicle component in the mounting space. The cover portion can be inclined or curved and configured to seat the vehicle component.

In some implementations, the hook portion of the cover can be configured to, based on the cover being positioned in the open state and the vehicle component entering the mounting space in the housing, be pushed by the vehicle component to thereby cause the cover portion to rotate together with the hook portion such that the vehicle component is accommodated inside the mounting space.

In some examples, the fixing device can include a fastening member that is configured to, based on the vehicle component entering the mounting space in the housing and the cover being positioned in a closed state, be fastened to the housing and the cover, or to the housing, the cover, and the vehicle component.

In some implementations, the removable fixing device for a vehicle component can allow a convenience component to be mounted to or removed from the interior of the vehicle, thereby ensuring greater flexibility in the use of the convenience component and improving the convenience of use.

The removable fixing device can also allow a device for fixing a convenience component to be separately mounted to or removed from the vehicle, thereby making it easy to replace the fixing device in the event of a malfunction and simplifying management.

In addition, the convenience component is easy to mount, enhancing the convenience of use.

### BRIEF DESCRIPTION OF THE DRAWINGS

FIG. 1 is a view illustrating an example of a removable fixing device for a vehicle component.

FIG. 2 is an enlarged view of the removable fixing device in FIG. 1.

FIG. 3 is a view illustrating a state before mounting a fixing unit in the removable fixing device.

FIG. 4 is a view illustrating a state after mounting a bracket of the removable fixing device.

FIG. 5 is a view illustrating an example of a fixing part.

FIG. 6 is a view illustrating an example of a first plate of an assembly part.

FIG. 7 is a view illustrating an example of a first fastening portion of the first plate.

FIG. 8 is a cross-sectional view of the first fastening portion illustrated in FIG. 7.

FIG. 9 is a view illustrating an example of a second plate of an assembly part.

FIG. 10 is a view illustrating an example of a third fastening portion of a second plate.

FIG. 11 is a cross-sectional view of the third fastening portion illustrated in FIG. 10.

FIG. 12 is a view illustrating an example of a second fastening portion of the second plate.

FIG. 13 is a view illustrating a state before mounting the coupling portion of the fixing unit through the second fastening portion.

FIG. 14 is a cross-sectional view taken along line A-A′ in FIG. 13.

FIG. 15 is a view illustrating a state after mounting the coupling portion of the fixing unit through the second fastening portion.

FIG. 16 is a cross-sectional view taken along line B-B′ in FIG. 15.

FIG. 17 is a view illustrating a state after mounting the fixing unit in the removable fixing device.

FIG. 18 is a view illustrating the fixing unit.

FIG. 19 is an exploded view of the fixing unit.

FIG. 20 is a view illustrating an example of a process for mounting a convenience component to the fixing unit.

FIG. 21 is a view showing a state after the convenience component fixed to the fixing unit.

### DETAILED DESCRIPTION

Hereinafter, one or more implementations will be described in detail with reference to the accompanying drawings, and the same or similar elements are given the same and similar reference numerals regardless of figure numbers, so duplicate descriptions thereof will be omitted.

The present disclosure describes a removable fixing device that enables a convenience component 400 to be mounted to or removed from the interior of a vehicle. Specifically, the fixing device includes a fixing part 100 and an assembly part 200 for mounting the convenience component 400, where the assembly part 200 to which the convenience component 400 is mounted can be mounted to or removed from the fixing part 100. This fixing device facilitates the replacement of the assembly part 200 in the event of a malfunction.

Through this structure, various convenience components 400 can be provided in the vehicle interior according to their intended use, and the management of the assembly part 200 becomes easier, improving user convenience.

In the present disclosure, the fixing part 100 and the assembly part 200 are described as being installed in the interior of a vehicle 10 as one exemplary embodiment. In some implementations, the fixing part 100 and the assembly part 200 can also be applied to various other spaces beyond the vehicle 10.

In addition, multiple fixing parts 100 can be provided at various positions within the interior of the vehicle 10. By selectively applying the assembly part 200 to each fixing part 100, convenience components 400 can be mounted at various positions in the vehicle interior.

The convenience components 400 can be applied in various ways, such as a cup holder, a pocket, or a hanger. In the present disclosure, the convenience component 400 is applied as a hanger for hanging clothes in an embodiment.

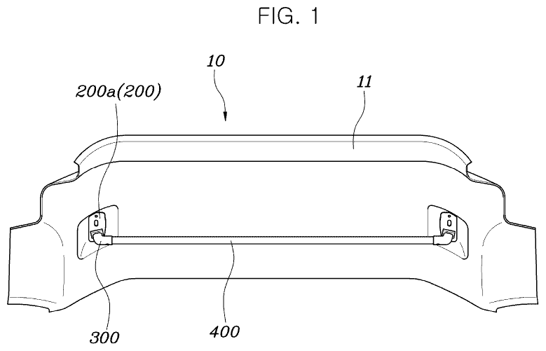

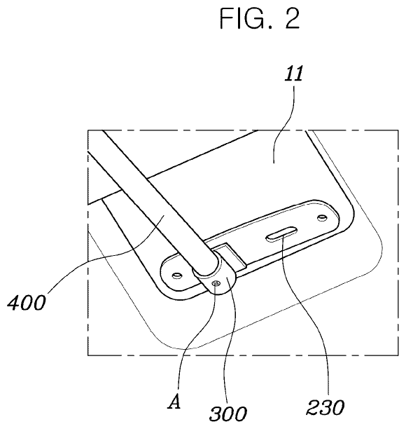

As illustrated in FIGS. 1 to 4, a removable fixing device for a vehicle component can include: a fixing part 100 having thereon at least one connection portion 110 and coupled to a vehicle 10; an assembly part 200 including a first fastening portion 210 that is fastened to the connection portion 110 of the fixing part 100 to be mounted to or removed from the fixing part 100, and at least one second fastening portion 220 spaced apart from the first fastening portion 210; and a fixing unit 300 including a coupling portion 310 that is mounted to or removed from the second fastening portion 220 of the assembly part 200, to allow a convenience component 400 to be attached to or detached from the fixing unit 300.

The fixing part 100 can be provided in the interior of the vehicle 10 and can be joined to the interior material. The fixing part 100 can include a connection portion 110 for mounting the assembly part 200. Multiple connection portions 110 can be provided to ensure that the assembly part 200 is firmly fixed to the fixing part 100.

The assembly part 200 includes the first fastening portion 210 that is fastened to the connection portion 110 of the fixing part 100, and the first fastening portion 210 can be mounted to or removed from the connection portion 110. The first fastening portion 210 can be assembled to the connection portion 110 through a fitting method. In addition, the assembly part 200 can be provided with one or more second fastening portions 220 for mounting the fixing unit 300 so that the fixing unit 300 can be mounted according to various convenience components 400.

The fixing unit 300 can include a coupling portion 310 that is mounted to the second fastening portion 220 of the assembly part 200, and the coupling portion 310 can be mounted to or removed from the second fastening portion 220. The coupling portion 310 can be assembled in a fitting manner to the second fastening portion 220. In the present disclosure, the coupling portion 310 can be mounted to the second fastening portion 220 through a rotating operation in the state of being inserted into the second fastening portion 220.

In addition, the fixing unit 300 can be configured to allow a convenience component 400 be detached and attached, so that various convenience components 400 can be mounted to the fixing unit 300 and used according to a user's needs.

In this way, the present disclosure allows the fixing parts 100 to be fixed to the interior of the vehicle 10, and the assembly part 200 and the fixing unit 300 to be mounted to each fixing part 100 according to the user's needs, thereby enabling the application of convenience components 400 that meets the user's needs. The assembly part 200 is removable from the fixing part 100, and even if the assembly part 200 is damaged during the process of mounting or fixing the fixing unit 300 to or from the assembly part 200, thereby ensuring convenience of use.

The above-described disclosure is specifically described as follows.

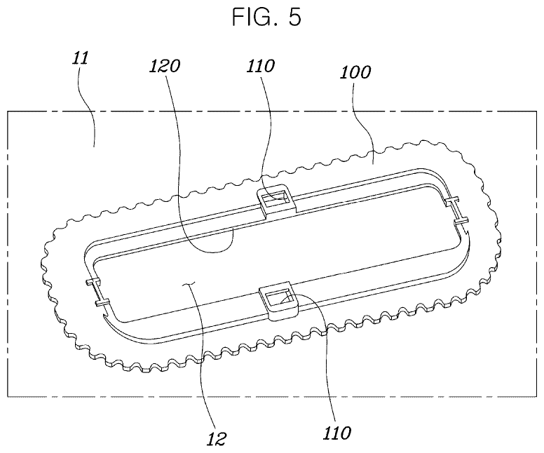

As illustrated in FIG. 5, the fixing part 100 can be joined to a panel portion 11 of the vehicle 10, the panel portion 11 can be provided with a through-hole 12 to accommodate a portion of the assembly part 200. The fixing part 100 can be provided with a corresponding through portion 120 that matches the through-hole 12.

The panel portion 11 of the vehicle 10 can be a vehicle body or an interior material, and in this disclosure, it is assumed that the fixing part 100 is joined to the interior material. The fixing part 100 can be joined to the interior material through bonding and can also be fixed to the panel portion 11 by various methods such as bolting or riveting.

The panel portion 11 is provided with the through-hole 12 to accommodate a portion of the assembly part 200, and the fixing part 100 is provided with a corresponding through portion 120 that matches the through-hole 12. The corresponding through portion 120 can be formed in the same hole shape as the through-hole 12, and the through-hole 12 and the corresponding through portion 120 can be configured to match each other in shape and size.

In the present disclosure, the fixing part 100 can be made of a rigid body, including plastic or steel. By being joined to the panel portion 11 of the vehicle 10, the fixing part 100 can provide a support structure for the panel portion 11 when the assembly part 200 is mounted in the interior of the vehicle 10, and can prevent damage to the panel portion 11 caused by the mounting of the assembly part 200. Accordingly, the fixing part 100 can be provided to cover the area around the through-hole 12 of the panel portion 11, and can have an outer shape that can be determined in various ways depending on design elements.

The fixing part 100 can include a plurality of connection portions 110 having holes arranged along the edge thereof.

The assembly part 200 can be provided with a plurality of first fastening portions 210 in the same number and at the same locations as the connection portions 110, and the first fastening portions 210 can be mounted by being inserted through the connection portions 110.

In the present disclosure, the connection portions 110 can be provided along the edge in an even number and arranged symmetrically or asymmetrically relative to the center, allowing the fixing part 100 to support the load generated during the mounting of the assembly part 200.

When the assembly part 200 is arranged to face the fixing part 100, the first fastening portions 210 can be provided to match the respective connection portions 110. Through this, as the assembly part 200 is moved toward the fixing part 100, the first fastening portions 210 can be inserted through the connection portions 110, thereby fixing the assembly part 200 to the fixing part 100.

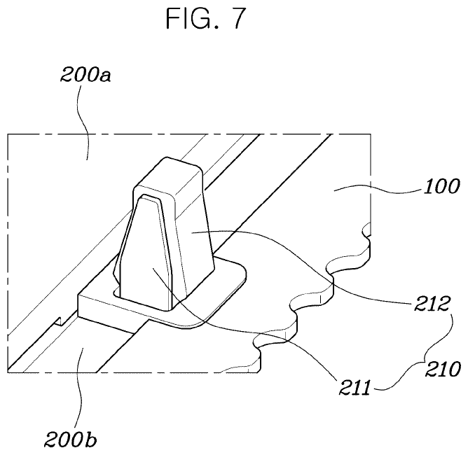

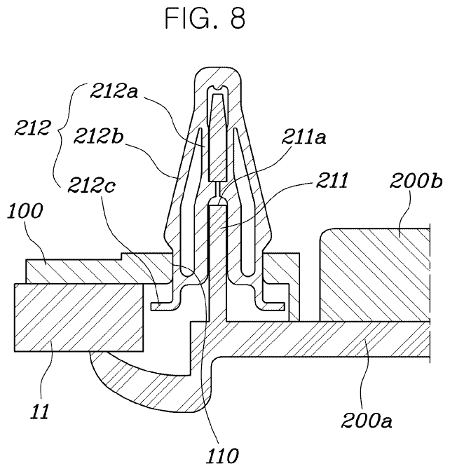

Specifically, as illustrated in FIGS. 5 to 11, the assembly part 200 can include a first plate 200a and a second plate 200b.

In some implementations, the first plate 200a can be provided with at least one slot 230, and first fastening portions 210 that are respectively coupled to the connection portions 110 of the fixing part 100. The first plate 200a can be made of a rigid material including plastic or steel, and a plurality of first fastening portions 210 can be provided along the edge to match the connection portions 110 of the fixing part 100. In addition, the one or more slots 230 can be provided on the first plate 200a as holes extending linearly. Since the slots 230 are the areas where the fixing units 300 are mounted, the slots are arranged in the central portion of the first plate 200a to ensure the self-supporting strength of the first plate 200a.

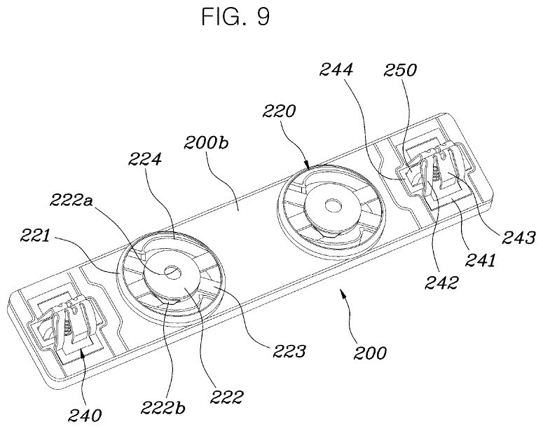

As illustrated in FIG. 9, the second plate 200b is provided with second fastening portions 220 that match the slots 230, and the coupling portion 310 of the fixing unit 300 can be mounted through the second fastening portions 220.

The second plate 200b can include a plastic material and can be made to be partially deformable. The second fastening portions 220 can be arranged on the second plate 200b to match in position and correspond in number to the slots 230 of the first plate 200a. The second fastening portions 220 are the portions where the coupling portion 310 of the fixing unit 300 is to be mounted. In the present disclosure, since the fixing unit 300 is configured to be mounted or removed through insertion and rotation into or from the second fastening portions 220, the second fastening portions 220 can be configured to allow partial deformation. The second fastening portions 220 on the second plate 200b can be integrally formed or separately manufactured and joined to the second plate 200b so that only the second fastening portions 220 are allowed to be deformed.

The first plate 200a can be disposed closer to the interior side than the second plate 200b and can cover the second plate 200b.

That is, in the assembled state of the first plate 200a and the second plate 200b, the first plate 200a can be exposed on the interior side of the vehicle 10, while the second plate 200b can be provided within the through-hole 12 in the panel portion 11. Accordingly, the assembly part 200 ensures that mechanical elements are invisible from the interior, and only the first plate 200a is exposed within the interior, allowing for the enhancement of the design elements of the first plate 200a to achieve a sense of luxury.

In addition, the fixing unit 300 is mounted to or removed from the assembly part 200 within the interior. During the mounting of the fixing unit 300, the coupling portion 310 of the fixing unit 300 can pass through a slot 230 of the first plate 200a to be mounted to a second fastening portion 220 of the second plate 200b. In some examples, the fixing unit 300 can be brought into contact with the first plate 200a to form a support structure, while the coupling portion 310 can pass through the slot 230 of the first plate 200a to be mounted to the second fastening portion 220 of the second plate 200b to a fixing structure.

The assembly structure of the fixing part 100 and the first plate 200a of the assembly part 200 in the present disclosure is described in detail as follows.

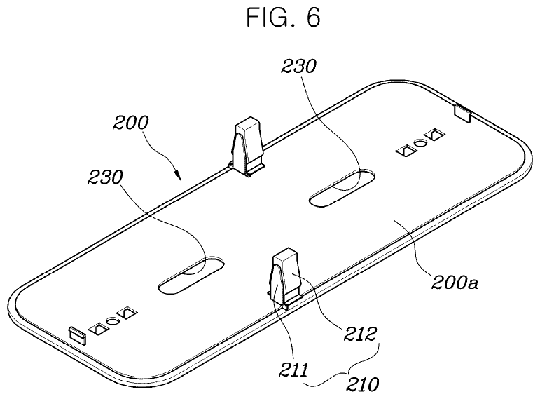

As illustrated in FIGS. 6 to 8, a first fastening portion 210 includes a fixing portion 211 and an assembly portion 212.

The fixing portion 211 can be fixed to the first plate 200a, can protrude from the first plate 200a, and can have a mounting hole 211a formed in a certain section. The fixing portion 211 can be integrally formed during the molding of the first plate 200a. In addition, the fixing portion 211 can protrude and extend in a direction orthogonal to the surface of the first plate 200a, and the mounting hole 211a can be formed in a certain section of the extended portion. The fixing portion 211 can be formed, for example, in an “H” shape when viewed from above, and the assembly portion 212 can be mounted in the central portion between the two side portions, and the mounting hole 211a can be formed in the central portion.

The assembly portion 212 is configured such that the fixing portion 211 is inserted thereinto, and can include a fitting portion 212a fitted into the mounting hole 211a, an inclined portion 212b elastically deformable from the outside, and an engagement end 212c fastened to the connection portion 110 at the distal end of the fitting portion 212a or inclined portion 212b.

That is, the central portion of the fixing portion 211 is inserted into the fitting portion 212a, and the fitting portion has a protrusion configured to be fitted into the mounting hole 211a, allowing the assembly portion 212 to be fixed by being engaged and connected to the fixing portion 211 via the fitting portion 212a.

The inclined portion 212b can be inclined outward from the fitting portion 212a and can be made to elastically deformable inward and outward. Here, regarding the terms “inward and outward”, the direction toward the fixing portion 211 inserted into the fitting portion 212a is the inward direction, and the opposite direction is the outward direction.

In addition, the engagement end 212c can be formed at the distal end of the fitting portion 212a or the inclined portion 212b. In the present disclosure, the engagement end 212c can be formed in a shape bent at the distal end of the inclined portion 212b, allowing the inclined portion 212b to be engaged with the fixing part 100 while passing through the connection portion 110 of the fixing part 100.

Through this, when the first fastening portion 210 of the first plate 200a of the assembly part 200 is mounted on the connection portion 110, the inclined portion 212b of the assembly portion 212 elastically contracts to pass through the connection portion 110 while the assembly portion 212 remains fixed to the fixing portion 211. Once passing through the connection portion 110, the inclined portion 212b elastically expands again, forming an engagement structure on one side of the fixing part 100, while the engagement end 212c forms an engagement structure on the opposite side of the fixing part 100, thereby fixing the assembly part 200 to the fixing part 100.

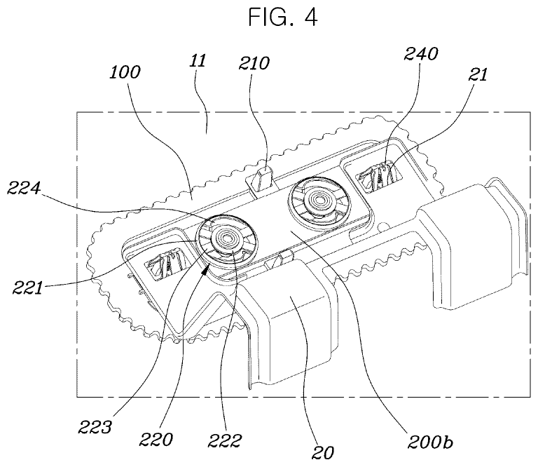

In some examples, as shown in FIG. 4, the second plate 200b can further include at least one third fastening portion 240 configured to be fastened to a bracket 20 fixed to the vehicle 10.

The vehicle 10 can be provided with a bracket 20 fixed to the vehicle body. Since the bracket 20, which is fixed to the vehicle body, provides a strong coupling force compared to the panel portion 11 of the vehicle 10, the assembly part 200 can be fixed with a strong fastening force when the second plate 200b is mounted to the bracket 20.

To mount the second plate 200b to the bracket 20 in this way, the second plate 200b is further provided with a third fastening portion 240. The third fastening portion 240 can be spaced apart from the second fastening portion 220 and can be provided in plurality at opposite ends of the second plate 200b.

Specifically, as illustrated in FIGS. 9 to 11, the third fastening portion 240 can include a seating portion 241 seated on the second plate 200b, a pair of support portions 242 extending and inclined from the seating portion 241 and joined at their ends to form an inner space, and an engagement portion 243 connected to the support portions 242 and configured to be deformable inward and outward.

The seating portion 241 can be formed in a ring or rectangular frame shape, and can be in contact with the surface of the second plate 200b to form a support structure for the second plate 200b.

A pair of support portions 242 can be provided and can extend to be inclined from the seating portion 241 such that their extended ends converge. As a result, when the support portions 242 are mounted to the bracket 20, the inclined surfaces of the support portions 242 allow for smooth insertion into a penetrated portion of the bracket 20. In addition, the support portions 242 are inclined to form an inner space therebetween, allowing the engagement portions 243 to be deformed into this space. As will be described below, a fastening member A can be inserted into the space between the support portions 242, thereby connecting the third fastening portion 240 to the second plate 200b and other components via the fastening member A.

The engagement portions 243 can be connected to the support portions 242, formed to protrude further outward than the support portions 242, and configured to be deformable. These engagement portions 243 can form an engagement structure on the bracket 20 through an inward and outward deformation motion.

Specifically, a fastening hole 21 can be formed in the bracket 20, and the engagement portions 243 of the third fastening portion 240 are inclined at a larger angle than the support portions 242 to protrude outward beyond the support portions 242. When the third fastening portion 240 is fastened to the bracket 20, the engagement portions 243 can pass through the fastening hole 21 and be engaged with the bracket 20 through a contracting and expanding action.

The fastening hole 21 in the bracket 20 can be formed to match the outer shape of the support portions 242 of the third fastening portion 240, and can be provided in plurality.

Specifically, in the third fastening portion 240, the engagement portions 243 can be formed to be inclined in accordance with the inclined shape of the support portions 242, but at a larger angle than the support portions 242, protruding outward beyond the support portions 242. For example, the outward direction can refer to the direction opposite to the space between the pair of support portions 242. Through this, the engagement portions 243 can be deformed into the space between the support portions 242 or protrude outward beyond the support portions 242. As a result, when the third fastening portion 240 is fastened to the bracket 20, the engagement portions 243 contract while the support portions 242 pass through the fastening hole 21, and the engagement portions 243 expand again once passing through the fastening hole 21, forming an engagement structure on the bracket 20. As a result, the third fastening portion 240 can be mounted to the bracket 20, and the second plate 200b, which includes the third fastening portion 240, can be fixed to the bracket 20.

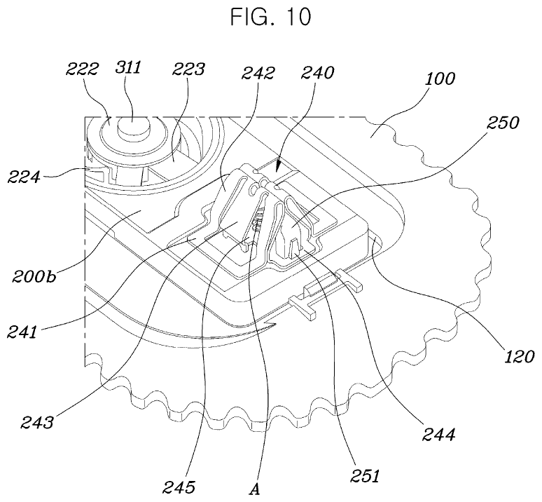

In some examples, as illustrated in FIG. 10, at least one mounting portion 250 can protrude from the second plate 200b, and an engagement protrusion 251 can protrude from the mounting portion 250.

The third fastening portion 240 is provided with a mounting end portion 244, through which the mounting portion 250 is inserted, on the seating portion 241, so that, when the mounting portion 250 passes through the mounting end portion 244, the engagement protrusion 251 can be engaged with the mounting end portion 244 and fixed.

In some examples, the mounting portion 250 can be integrally formed with the second plate 200b, but can also be separately manufactured and joined. The mounting portion 250 is provided at the position where the third fastening portion 240 is mounted, and the engagement protrusion 251 extends from one surface of the mounting portion 250.

The third fastening portion 240 can be provided with the mounting end portion 244 at a portion of the seating portion 241, and the mounting end portion 244 can include a hole through which the mounting portion 250 can be inserted. Through this, when the third fastening portion 240 is coupled to the second plate 200b, the mounting portion 250 of the second plate 200b can be inserted through the mounting end portion 244 of the third fastening portion 240. During this process, the mounting end portion 244 can pass over the engagement protrusion 251 of the mounting portion 250, so that the third fastening portion 240 can be engaged with and fixed to the mounting portion 250.

The aforementioned mounting portion 250 can be formed in a curved shape for smooth insertion of the mounting end portion 244. The engagement protrusion 251 can be inclined in the direction in which the mounting end portion 244 is inserted and formed at an angle in the direction in which the mounting end portion 244 is removed after passing therethrough, ensuring that the mounting state of the third fastening portion 240 is maintained.

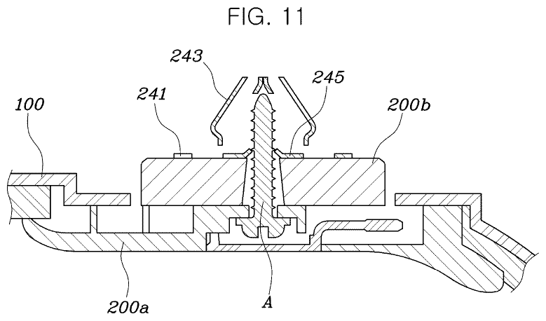

In some examples, as illustrated in FIGS. 10 and 11, the third fastening portion 240 can further include an extension 245 connected to at least one of the seating portion 241, the support portions 242, and the engagement portions 243 in the space between the support portions 242. Referring to FIG. 10, the extension 245 can be connected to the engagement portions 243, can have a predetermined area, and can include a hole to allow the fastening member A to pass therethrough. The fastening member A may, for example, be a bolt.

Through this, the fastening member A can be fastened through the first plate 200a, the second plate 200b, and the extension 245 of the third fastening portion 240, allowing the first plate 200a, the second plate 200b, and the third fastening portion 240 to be assembled together via the fastening member A.

That is, by coupling the first plate 200a, the second plate 200b, and the third fastening portion 240 with a single fastening member A, assembly convenience can be ensured, and the structure for assembling individual components can be simplified.

In some examples, the slot 230 of the first plate 200a can be formed to extend linearly, and the coupling portion 310 of the fixing unit 300 can be formed to match the slot 230 and to extend linearly.

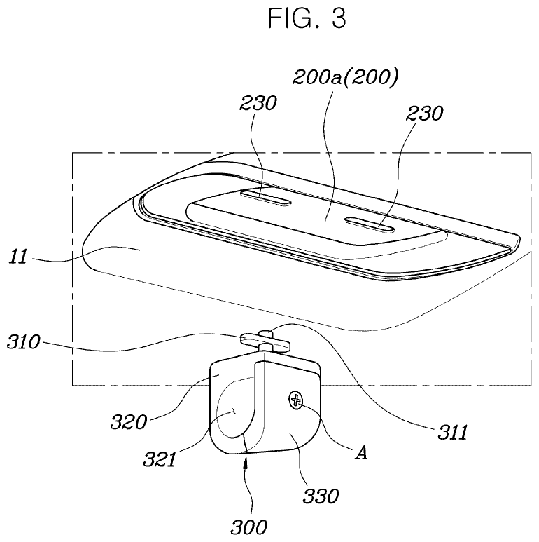

In some implementations, as illustrated in FIGS. 3 and 6, the slot 230 is formed to allow the coupling portion 310 to pass therethrough, and the slot 230 and the coupling portion 310 of the fixing unit 300 are formed in a shape extending linearly, thereby allowing the coupling portion 310 to be fixed to the second plate 200b by rotating the coupling portion 310 after being inserted into the slot 230.

In some examples, the detailed connection structure between the second fastening portion 220 and the coupling portion 310 is as follows.

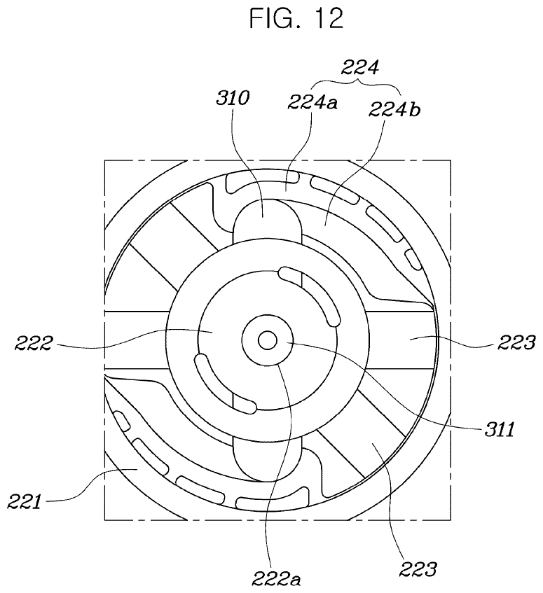

As illustrated in FIGS. 12 to 16, the second fastening portion 220 can include a peripheral portion 221 circularly penetrated in the second plate 200b, a contact portion 222 located at the center of the peripheral portion 221 to support the coupling portion 310 of the fixing unit 300, a bridge portion 223 connecting the peripheral portion 221 and the contact portion 222, and locking portions 224 configured to restrict the position of the coupling portion 310 within a predetermined section during the rotation of the fixing unit 300 while the coupling portion 310 is in contact with the contact portion 222.

The peripheral portion 221 is formed in a circular shape and can be separately mounted on the second plate 200b or integrally formed with the second plate 200b. The inner side of the peripheral portion 221 can be formed to secure a space that allows the coupling portion 310 of the fixing unit 300 to rotate.

The contact portion 222 is the portion where the coupling portion 310 is brought into contact and is connected to the peripheral portion 221 via the bridge portion 223. This contact portion 222 supports the coupling portion 310 upon contact and can be formed in a circular shape to match the shape of the peripheral portion 221.

A plurality of bridge portions 223, which connect the peripheral portion 221 and the contact portion 222, can be provided and arranged to be spaced apart from each other. In particular, the bridge portions 223 can be configured to allow partial elastic deformation, thereby elastically supporting the coupling portion 310 supported by the contact portion 222.

The locking portions 224 are configured to restrict the position of the coupling portion 310 when the fixing unit 300 rotates and overlaps the coupling portion 310 while the coupling portion 310 is in contact with the contact portion 222. Specifically, the locking portions 224 can be formed in some sections along the inner circumference of the peripheral portion 221 and protrude inward from the peripheral portion 221 so that the coupling portion 310 is seated thereon. While the coupling portion 310 is in the seated state, the movement of the coupling portion 310 is restricted according to the rotational position of the coupling portion 310, thereby constraining the movement of the coupling portion 310 in the direction in which it has passed through the slot 230. For example, the locking portions 224 can be arranged at intervals of 90° along the inner circumferential direction of the peripheral portion 221, and no locking portion 224 may be provided in the remaining 90° section, allowing the coupling portion 310 to enter or exit through this section. In addition, when the coupling portion 310 is rotated to overlap the locking portions 224, the locking portions 224 can restrict the coupling portion 310 from moving in the direction in which it has passed through the slot 230.

In some examples, an insertion portion 311 can protrude from the center of the coupling portion 310 of the fixing unit 300, and an insertion hole 222a into which the insertion portion 311 is inserted can be formed in the contact portion 222.

The insertion portion 311 can be formed so that its central axis is aligned with that of the coupling portion 310 and can be formed in a conical shape.

The contact portion 222 can have an insertion hole 222a into which the insertion portion 311 is inserted, and the insertion hole 222a can be penetrated in a conical shape, allowing the inclined surface of the insertion portion 311 to come into contact with the surface of the insertion hole. Accordingly, when the fixing unit 300 is mounted to the assembly part 200, the state in which the insertion portion 311 is inserted into the insertion hole 222a can be maintained, preventing the distortion of the fixing unit 300, and the insertion portion 311 and the insertion hole 222a form a support structure, stabilizing the mounted state of the fixing unit 300.

In some examples, the locking portions 224 can each include a first guide portion 224a and a second guide portion 224b.

In some examples, the first guide portion 224a can be formed to extend in the circumferential direction of the peripheral portion 221 and gradually protrude inward, and the second guide portion 224b can be formed to extend in the circumferential direction together with the first guide portion 224a and to allow the coupling portion 310 to be seated thereon.

Specifically, the first guide portion 224a can be formed to gradually protrude inward from the peripheral portion 221 in the circumferential direction, so that the coupling portion 310 is engaged with the first guide portion 224a and is restricted when rotating toward the first guide portion 224a. The first guide portion 224a can be formed to additionally protrude in a curved shape at the end in the direction where the coupling portion 310 enters and moves, allowing the coupling portion 310 to be securely fixed when restricted by the first guide portion 224a.

The second guide portion 224b moves in the circumferential direction of the peripheral portion 221 together with the first guide portion 224a, ensuring that the coupling portion 310 moves along the first guide portion 224a while being in contact with the second guide portion 224b. The second guide portion 224b can be formed in the same section as the first guide portion 224a and can be configured to have a predetermined area to maintain the seated state of the coupling portion 310.

A protrusion 222b can be formed on the contact portion 222 to protrude in the direction facing the coupling portion 310 of the fixing unit 300, extend in the circumferential direction to guide the rotation of the coupling portion 310, and be recessed at a position where the rotation of the coupling portion 310 is constrained to constrain the rotation of the coupling portion 310.

That is, the locking portion 224 restricts the movement of the coupling portion 310 in the direction where it passes through the slot 230 to be mounted, and to maintain the constrained state of the coupling portion 310, the protrusion 222b on the contact portion 222 protrudes, ensuring that the constrained state of the coupling portion 310 is maintained. The protrusion 222b is formed to protrude from the contact portion 222, and when rotating to pass over the protrusion 222b, the coupling portion 310 can be restricted from rotating by the first guide portion 224a, thereby maintaining the constrained state of the fixing unit 300. Accordingly, the protrusion 222b can be formed to have an inclined surface so that the coupling portion 310 can pass over the protrusion 222b while in contact with it.

The process of mounting the coupling portion 310 of the fixing unit 300 through the aforementioned second fastening portion 220 is as follows.

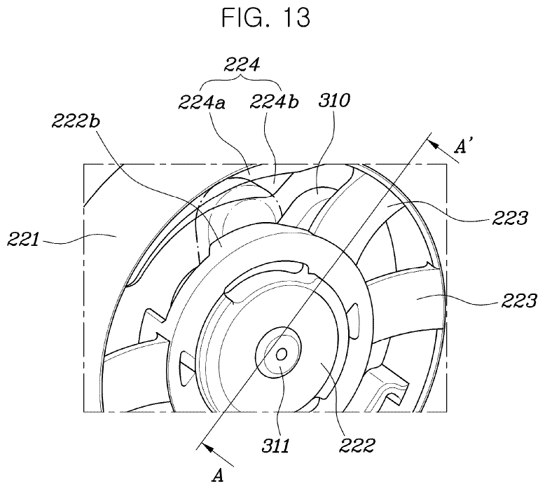

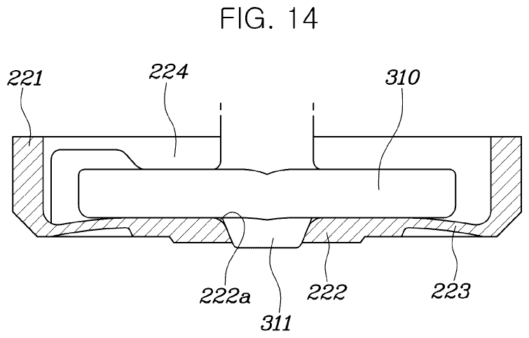

As shown in FIG. 13, the coupling portion 310 of the fixing unit 300 passes through the slot 230 in the first plate 200a and enters the second fastening portion 220 of the second plate 200b, and the coupling portion 310 comes into contact with the contact portion 222 of the second fastening portion 220 and is elastically supported. That is, as illustrated in FIG. 14, the coupling portion 310 of the fixing unit 300 is elastically supported while in contact with the contact portion 222.

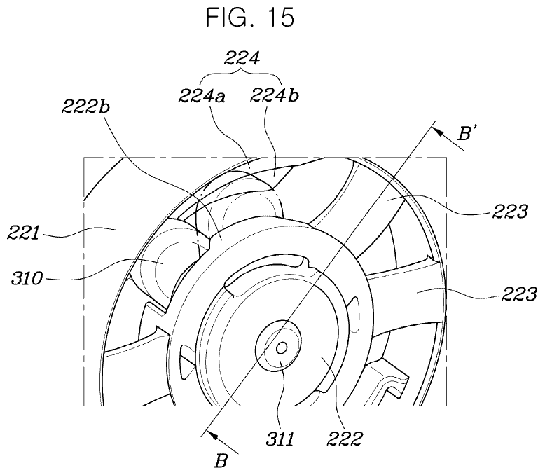

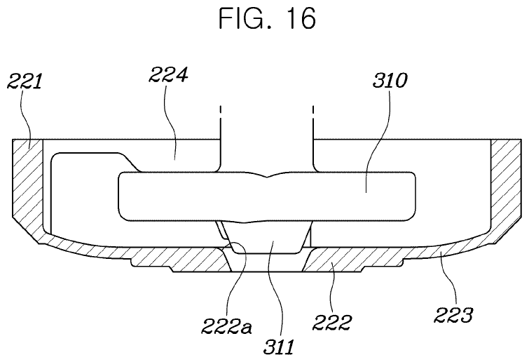

In some implementations, as illustrated in FIG. 15, when the fixing unit 300 is rotated, the coupling portion 310 enters and moves along the first guide portion 224a and the second guide portion 224b. At this time, the coupling portion 310 moves along the protrusion 222b of the contact portion 222 and the first guide portion 224a, thereby elastically pushing the contact portion 222. As illustrated in FIG. 16, the contact portion 222 and the connection portion 110 are deformed to become convex, thereby elastically supporting the coupling portion 310. When the coupling portion 310 continues to move due to the continuous rotation of the fixing unit 300 in this way, the coupling portion 310 is fixed between the locking portion 224 and the contact portion 222, so that the rotation can be restricted and the axial movement of the fixing unit 300 can be constrained.

In this way, when mounting the fixing unit 300 to the assembly part 200, the fixing unit 300 can be simply mounted to the assembly part 200 by passing the coupling portion 310 of the fixing unit 300 through the slot 230 in the first plate 200a, allowing it to enter the second fastening portion 220 of the second plate 200b, and then rotating it. The fixing unit 300 can be removed from the assembly part 200 through the opposite operation of the aforementioned mounting process.

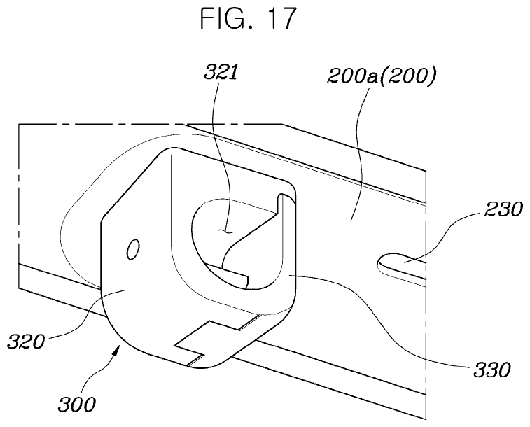

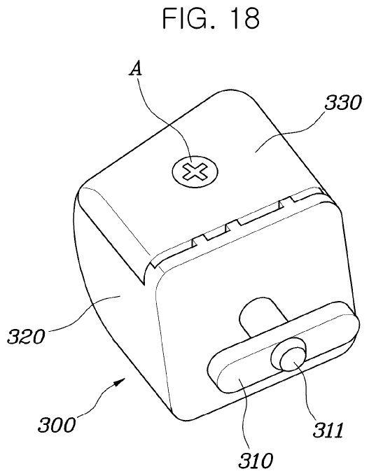

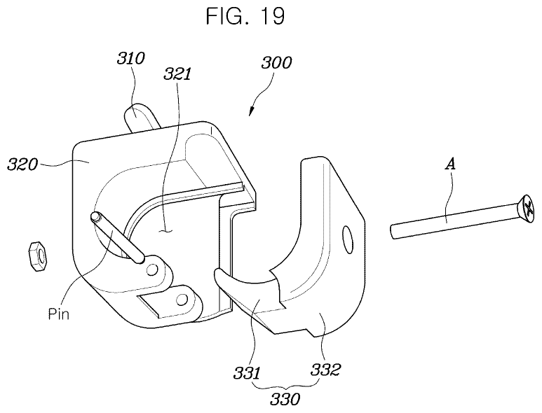

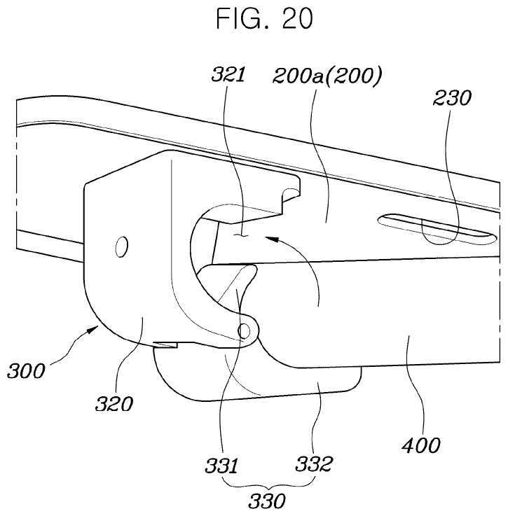

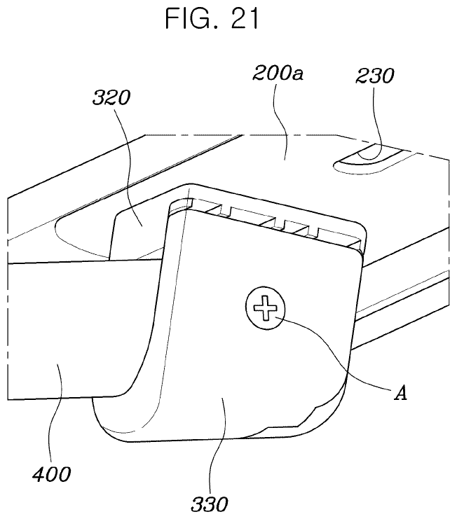

In some examples, as illustrated in FIGS. 17 to 21, the fixing unit 300 can include a housing 320 and a cover 330.

In some implementations, a coupling portion 310 can be provided outside the housing 320, and a mounting space 321 where a convenience component 400 is seated is defined inside the housing 320. The cover 330 can be rotatably connected to the housing 320 and can selectively cover a portion of the mounting space 321.

The cover 330 can be rotatably connected to the housing 320 via a hinge pin, and the convenience component 400 can be accommodated through the mounting space 321 in the housing 320. The mounting space 321 in the housing 320 can match the outer shape of the convenience component 400. In the drawings, the convenience component 400 can be a hanger rod, and the mounting space 321 can be cylindrically shaped to correspond to the outer shape of the hanger rod.

The cover 330, which is rotatably connected to the housing 320, opens or closes the mounting space 321 depending on its rotational position. This cover 330 can be formed to have a shape corresponding to a portion of the outer shape of the housing 320.

In particular, the cover 330 can include a hook portion 331 and a cover portion 332 that come into contact with a part or all of the convenience component 400.

The cover 330 can be rotatably connected to the housing 320 via the hinge pin, the hook portion 331 can be provided on one side about the hinge pin, and the cover portion 332 can be provided on the other side. The hinge pin can be connected to either the hook portion 331 or the cover portion 332.

In addition, the hook portion 331 and the cover portion 332 can be configured to partially enclose the outer shape of the convenience component 400. Accordingly, when the convenience component 400 is applied as a hanger rod, the hook portion 331 and the cover portion 332 can have a curved shape to partially enclose the outer shape of the hanger rod.

In this way, when the cover 330 is positioned in the open direction on the housing 320, the hook portion 331 can come into contact with the convenience component 400 in the mounting space 321 of the housing 320, while the cover portion 332 can be inclined or curved to allow the convenience component 400 to be seated therein.

As a result, when the cover 330 is positioned in the open direction on the housing 320 and the convenience component 400 enters the mounting space 321 in the housing 320, the convenience component 400 pushes the hook portion 331 of the cover 330, causing the cover portion 332 to rotate together. Consequently, the convenience component 400 can enter the mounting space 321 in the housing 320 while being enclosed by the cover 330. That is, when the convenience component 400 is accommodated in the mounting space 321 in the housing 320, the hook portion 331 of the cover 330 can be engaged first, and even without separately manipulating the cover 330, simply by moving the convenience component 400 into the mounting space 321 in the housing 320, the cover 330 and the cover portion 332 are linked and rotated along with the convenience component 400, thereby allowing the cover 330 to perform the operation of closing the mounting space 321 in the housing 320.

In some examples, when the convenience component 400 enters the mounting space 321 in the housing 320 and the cover 330 is positioned in the closed direction, the fixing unit 300 can fix the housing 320 and the cover 330, or the housing 320, the cover 330, and the convenience component 400, via a fastening member A.

For instance, the fastening member A can be configured with a bolt. With the convenience component 400 accommodated in the mounting space 321 of the housing 320 and the cover 330 positioned in the closed direction, a single fastening member A can fix the housing 320, the cover 330, and the convenience component 400 so that the coupled state is maintained.

Accordingly, matching holes can be formed in the housing 320, the cover 330, and the convenience component 400 to allow the fastening member A to be inserted therethrough. By fixing the housing 320, the cover 330, and the convenience component 400 with the single fastening member A, a simple fixing structure can be achieved without additional structures or components.

A removable fixing device for a vehicle component allows a convenience component 400 to be mounted to or removed from the interior of the vehicle 10, thereby ensuring greater flexibility in the use of the convenience component 400 and improving the convenience of use. The vehicle component may include the convenience component 400.

The removable fixing device also allows a device for fixing a convenience component 400 to be separately mounted to or removed from the vehicle 10, thereby making it easy to replace the fixing device in the event of a malfunction and simplifying management.

In addition, the convenience component 400 is easy to mount, enhancing the convenience of use.

Although the present disclosure has been described and illustrated in conjunction with particular embodiments thereof, it will be apparent to those skilled in the art that various improvements and modifications can be made to the present disclosure without departing from the technical idea of the present disclosure defined by the appended claims.

What is claimed is:

1. A fixing device for a vehicle component, the fixing device comprising:
a fixing part configured to be coupled to a vehicle, the fixing part comprising a connection portion;
an assembly part comprising (i) a first fastening portion that is fastened to the connection portion of the fixing part and configured to be mounted to and removed from the fixing part, and (ii) a second fastening portion spaced apart from the first fastening portion; and
a fixing unit comprising a coupling portion that is configured to be mounted to and removed from the second fastening portion of the assembly part, the fixing unit being configured to be attached to and detached from the vehicle component.

2. The fixing device of claim 1, wherein the fixing part is configured to be coupled to a panel portion of the vehicle, the panel portion having a through-hole configured to accommodate a portion of the assembly part, and
wherein the fixing part has a corresponding through-hole facing the through-hole of the panel portion.

3. The fixing device of claim 1, wherein the connection portion of the fixing part is one of a plurality of connection portions that are arranged along an edge of the fixing part and that define a plurality of through-holes, respectively, and
wherein the first fastening portion of the assembly part is one of a plurality of first fastening portions corresponding to the plurality of connection portions, respectively, each of the plurality of first fastening portions being inserted through and mounted in one of the plurality of connection portions.

4. The fixing device of claim 1, wherein the assembly part comprises:
a first plate comprising the first fastening portion configured to be fastened to the connection portion of the fixing part, the first plate defining at least one slot; and
a second plate comprising the second fastening portion matching the at least one slot of the first plate, and
wherein the coupling portion of the fixing unit is mounted to the assembly part through the second fastening portion.

5. The fixing device of claim 4, wherein the first plate covers the second plate and is disposed inward toward an interior of the vehicle relative to the second plate, and
wherein the coupling portion of the fixing unit passes through the at least one slot in the first plate and is mounted to the second fastening portion of the second plate.

6. The fixing device of claim 4, wherein the first fastening portion comprises:
a fixing portion that is fixed to the first plate and protrudes outward from the first plate, the fixing portion defining a mounting hole; and
an assembly portion that receives the fixing portion, the assembly portion comprising:
a fitting portion configured to be fitted into the mounting hole of the fixing portion,
an inclined portion having an exterior configured to elastically deform, and
an engagement end portion fastened to the connection portion and disposed at a distal end of the fitting portion or the inclined portion.

7. The fixing device of claim 4, wherein the second plate further comprises a third fastening portion fastened to a bracket that is fixed to the vehicle.

8. The fixing device of claim 7, wherein the third fastening portion comprises:
a seating portion seated on the second plate;
a pair of support portions that extend from the seating portion and are inclined with respect to the seating portion, wherein the pair of support portions define a space therebetween, and ends of the pair of support portions are connected to each other; and
a pair of engagement portions connected to the pair of support portions, respectively, and configured to elastically deform inward or outward relative to the pair of support portions.

9. The fixing device of claim 8, wherein the second plate comprises a mounting portion that protrudes from the second plate, and an engagement protrusion that protrudes from the mounting portion, and
wherein the third fastening portion further comprises a mounting end portion disposed at the seating portion and configured to receive the mounting portion, and
wherein the engagement protrusion is configured to be fixedly engaged with the mounting portion based on the mounting portion passing through the mounting end portion.

10. The fixing device of claim 8, wherein the bracket has a fastening hole defined therein, and
wherein the pair of engagement portions are inclined at a greater angle than the pair of support portions and protrude outward relative to the pair of support portions, and
wherein the pair of engagement portions are configured to engage with the bracket by passing through the fastening hole and a contracting and expanding action to thereby fasten the third fastening portion to the bracket.

11. The fixing device of claim 8, wherein the third fastening portion further comprises an extension disposed in the space between the pair of support portions and connected to at least one of the seating portion, the pair of support portions, or the pair of engagement portions, and
wherein the first plate, the second plate, and the third fastening portion are assembled via a fastening member that passes through and is fastened to the first plate, the second plate, and the extension of the third fastening portion.

12. The fixing device of claim 4, wherein the at least one slot in the first plate extends linearly, and
wherein the coupling portion of the fixing unit has a shape corresponding to the at least one slot and is configured to be fixed to the second plate based on the coupling portion being inserted through the at least one slot in the first plate and then being rotated.

13. The fixing device of claim 12, wherein the second fastening portion comprises:
a peripheral portion that surrounds a circular hole defined through the second plate;
a contact portion positioned at a center of the peripheral portion and configured to support the coupling portion of the fixing unit;
a bridge portion connecting the peripheral portion to the contact portion; and
a locking portion configured to constrain a position of the coupling portion based on a rotation of the fixed unit while the coupling portion of the fixing unit is in contact with the contact portion.

14. The fixing device of claim 13, wherein the coupling portion of the fixing unit comprises an insertion portion that protrudes from a center thereof, and
wherein the contact portion defines an insertion hole configured to receive the insertion portion.

15. The fixing device of claim 13, wherein the locking portion comprises:
a first guide portion that extends in a circumferential direction of the peripheral portion and protrudes radially inward; and
a second guide portion that extends in the circumferential direction with the first guide portion and is configured to seat the coupling portion thereon.

16. The fixing device of claim 15, wherein the contact portion comprises:
a protrusion that protrudes in a direction facing the coupling portion of the fixing unit, that extends in the circumferential direction, and that is configured to guide a rotation of the coupling portion, the protrusion having a recess configured to constrain the rotation of the coupling portion.

17. The fixing device of claim 1, wherein the fixing unit comprises:
a housing that defines a mounting space configured to accommodate the vehicle component, wherein the coupling portion is provided outside the housing; and
a cover that is rotatably connected to the housing and configured to cover a portion of the mounting space.

18. The fixing device of claim 17, wherein the cover comprises a hook portion and a cover portion that are configured to come into contact with at least a part of the vehicle component,
wherein the hook portion is configured to, based on the cover being positioned in an open state, come into contact with the vehicle component in the mounting space, and
wherein the cover portion is inclined or curved and configured to seat the vehicle component.

19. The fixing device of claim 18, wherein the hook portion of the cover is configured to, based on the cover being positioned in the open state and the vehicle component entering the mounting space in the housing, be pushed by the vehicle component to thereby cause the cover portion to rotate together with the hook portion such that the vehicle component is accommodated inside the mounting space.

20. The fixing device of claim 17, further comprising a fastening member that is configured to, based on the vehicle component entering the mounting space in the housing and the cover being positioned in a closed state, be fastened to the housing and the cover, or to the housing, the cover, and the vehicle component.
